(19) United States
(12) Patent Application Publication
(10) Pub. No.: US 2010/0301248 A1
(43) Pub. Date: Dec. 2, 2010

(54) SOLENOID VALVE

(75) Inventors: Haruki Yamamoto, Anjo-shi (JP); Kota Fukao, Anjo-shi (JP); Kazunori Ishikawa, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi, Aichi-ken (JP)

(21) Appl. No.: 12/811,170

(22) PCT Filed: Jun. 24, 2009
(86) PCT No.: PCT/JP09/61469

§ 371 Date: Jun. 29, 2010

(30) Foreign Application Priority Data
Jun. 27, 2008 (JP) 2008-0168652

(51) Int. Cl. F16K 31/02

(52) U.S. Cl. 251/129.15

(57) ABSTRACT

A spool is constituted by an outer spool 60 for opening and closing ports 52, 54, 56 provided in a sleeve 50 and an inner spool 70 that is contacted by a shaft 38 of a solenoid portion 30 and opens and closes a feedback chamber 58. A spring 80, which is interposed between the outer spool 60 and the inner spool 70, is designed to be capable of receiving precisely a total load of a load applied to the outer spool 60 by a feedback force generated when an output pressure reaches a predetermined pressure P1 and a load applied to the outer spool 60 by a biasing force of a spring 44. Therefore, by pushing the inner spool 70 using the solenoid portion 30 such that the outer spool 60 is moved in an axial direction via the spring 80, the respective ports 52, 54, 56 can be opened and closed, and the feedback chamber 58 can be opened from a closed state by the biasing force of the spring 80.

### CROSS REFERENCE TO RELATED APPLICATIONS

This application is a National Stage of International Application No. PCT/JP2009/061469 filed Jun. 24, 2009, claiming priority from Japanese Patent Application No. 2008-168652, filed Jun. 27, 2008, the contents of all of which are incorporated herein by reference in their entirety.

### BACKGROUND OF THE INVENTION

The present invention relates to a solenoid valve, and more particularly to a solenoid valve including: a hollow sleeve formed with ports including an input port, an output port, and a discharge port; a spool that is a shaft-shaped member inserted into the interior of the sleeve and connects and disconnects the respective ports; and a solenoid portion having a movable member for moving the spool in an axial direction.

### DESCRIPTION OF THE RELATED ART

A valve of the related art proposed as this type of solenoid valve includes: a sleeve formed with ports including an input port, an output port, and a drain port; a pressure regulating valve portion constituted by a hollow outer spool disposed in the sleeve to be capable of moving inward and outward and an inner spool inserted into the interior of the outer spool to be capable of opening and closing a feedback hole; and a linear solenoid portion that generates thrust for pushing the inner spool (see Japanese Patent Application Publication No. JP-A-2005-155893, for example). This solenoid valve is provided with a first spring that biases the outer spool toward the linear solenoid portion and a second spring that is provided between the outer spool and the inner spool, has a smaller spring constant than that of the first spring, and biases the outer spool and inner spool relative to each other. In an initial state in which electrification of a coil of the linear solenoid portion is OFF, the input port and output port are open while the drain port and the feedback hole are closed, and when a current is applied to the coil of the linear solenoid portion, the inner spool is pushed by thrust from the linear solenoid portion. As a result, the inner spool moves while the second spring having a smaller spring constant contracts, thereby opening the feedback hole, and the first spring having a large spring constant does not contract, and therefore the position of the outer spool is maintained such that the input port and output port remain open and the drain port remains closed. When the current applied to the linear solenoid portion is further increased, the first spring also contracts, causing the outer spool to move such that a passage between the input port and output port is narrowed, and thus an output pressure is regulated.

### SUMMARY OF THE INVENTION

In the solenoid valve described above, when a state in which the output pressure is at a maximum by turning electrification of the coil of the linear solenoid portion OFF is switched to a state in which the output pressure is regulated, a greater thrust than a biasing force of the second spring needs be generated from the linear solenoid portion to move the inner spool, and therefore a comparatively large current must be applied until the feedback hole is opened such that a feedback pressure acts on the outer spool, which may lead to hysteresis. This hysteresis affects the responsiveness of the output pressure, and therefore, it is preferable that the hysteresis be minimized.

A main object of a solenoid valve according to the present invention is to reduce hysteresis in an output pressure.

To achieve the main object described above, the solenoid valve according to the present invention employs the following means.

The solenoid valve according to a first aspect of the present invention includes a hollow sleeve formed with ports including an input port, an output port, and a discharge port, a spool that is a shaft-shaped member inserted into an interior of the sleeve and connects and disconnects the respective ports, and a solenoid portion that moves the spool in an axial direction. In the solenoid valve, the spool includes: a first spool which forms a feedback chamber, into which an output pressure is introduced, together with the sleeve, and which is capable of regulating an input pressure from the input port and outputting the regulated input pressure to the output port by moving in the axial direction while receiving a feedback force; a second spool which is pushed by the solenoid portion and switched so as to introduce the output pressure into the feedback chamber and close the feedback chamber; and a biasing member which is provided between the first spool and the second spool so as to bias the first spool and the second spool relative to each other, and the biasing member is formed such that when the second spool is pushed by the solenoid portion, the first spool is pushed from the second spool via the biasing member so as to move in the axial direction.

In the solenoid valve according to the first aspect of the present invention, the spool is constituted by the first spool which forms the feedback chamber, into which the output pressure is introduced, together with the sleeve, and which is capable of regulating the input pressure from the input port and outputting the regulated input pressure to the output port by moving in the axial direction while receiving the feedback force, the second spool which is pushed by the solenoid portion and switched so as to introduce the output pressure into the feedback chamber and close the feedback chamber, and the biasing member which is provided between the first spool and the second spool so as to bias the first spool and the second spool relative to each other. The biasing member is formed such that when the second spool is pushed by the solenoid portion, the first spool is pushed from the second spool via the biasing member so as to move in the axial direction. Hence, the respective ports can be connected and disconnected by moving the outer spool without having the solenoid portion push the outer spool directly. Further, the biasing member is used to open the feedback chamber, and therefore hysteresis in the output pressure can be reduced.

The solenoid valve according to the first aspect of the present invention may be constituted so that when an initial state in which the output pressure has a value of substantially zero is established, the feedback chamber is open, when the output pressure is low, the feedback chamber is kept open as the second spool is pushed by the solenoid portion such that the first spool is pushed and moved without causing the biasing member to contract, and when the output pressure becomes high in accordance with the movement of the first spool, an additional pushing force is applied to cause the solenoid portion to push the second spool, and the second spool moves relative to the first spool while the biasing member contracts such that the feedback chamber is closed by the second spool. Hence, by reducing the thrust of the solenoid portion while the output pressure is high, the biasing force of the biasing member can be used to open the feedback chamber, and therefore, in comparison with a construction in which the feedback chamber is opened by generating thrust that opposes the biasing force of the biasing member from the solenoid portion, hysteresis in the output pressure can be reduced even more reliably.

Further, in the solenoid valve according to the first aspect of the present invention, the biasing member may be formed such that in the initial state where the solenoid portion is OFF, a predetermined initial load acts on the first spool and the second spool. The solenoid valve according to the first aspect of the present invention may further include a second biasing member that biases the first spool in an opposite direction to a direction of the pushing force from the solenoid portion. In the solenoid valve, the feedback chamber may be formed such that the feedback force acts in an identical direction to a biasing direction of the second biasing member, and the biasing member may be formed such that a load based on the biasing force of the second biasing member and the feedback force acts on the first spool and the second spool as the predetermined initial load. Thus, the initial load can be normalized, enabling reduction in the thrust required by the solenoid portion. In this case, the solenoid valve may be constituted in which when a current applied to the solenoid portion is smaller than a predetermined value, the output pressure varies linearly relative to variation in the applied current, and when the current applied to the solenoid portion reaches or exceeds the predetermined value, the output pressure varies in a substantially stepwise manner relative to variation in the applied current, and further, the initial load is set on the basis of a total load of a load applied to the first spool by a feedback force based on the output pressure when the current applied to the solenoid portion reaches the predetermined value and a load applied to the first spool by the second biasing member. Thus, the initial load can be minimized, and as a result, the thrust required by the solenoid portion can be suppressed to a minimum.

Further, in the solenoid valve according to the first aspect of the present invention, a discharge passage may be formed to discharge a working fluid from the interior of the feedback chamber, and the second spool may be formed to block the discharge passage when opening the feedback chamber and open the discharge passage when closing the feedback chamber. Hence, the generation of residual pressure in the feedback chamber when the feedback chamber is closed can be prevented more reliably.

Further, in the solenoid valve according to the first aspect of the present invention, the first spool may be a hollow member, and the second spool may be inserted into the first spool to be slidable in the axial direction such that a movable range of the second spool is restricted by the first spool. Thus, the movable range of the second spool can be set using a simple construction.

### BRIEF DESCRIPTION OF THE DRAWINGS

FIG. 1 is a schematic constitutional diagram showing the constitution of a solenoid valve 20 according to an embodiment of the present invention;

FIG. 2 is a partial constitutional diagram showing a part of a hydraulic circuit 10 including the solenoid valve 20 according to this embodiment;

FIGS. 3A to 3C are illustrative diagrams illustrating an operation of the solenoid valve 20 according to this embodiment;

FIG. 4 is an illustrative diagram illustrating a relationship between a current I and an output pressure;

FIG. 5 is a schematic constitutional diagram showing the constitution of a solenoid valve 120 according to a modified example;

FIGS. 6A to 6C are illustrative diagrams illustrating an operation of the solenoid valve 120 according to this modified example; and

FIG. 7 is a schematic constitutional diagram showing the constitution of a solenoid valve 120B according to a modified example.

### DETAILED DESCRIPTION OF THE EMBODIMENT

Next, an embodiment of the present invention will be described.

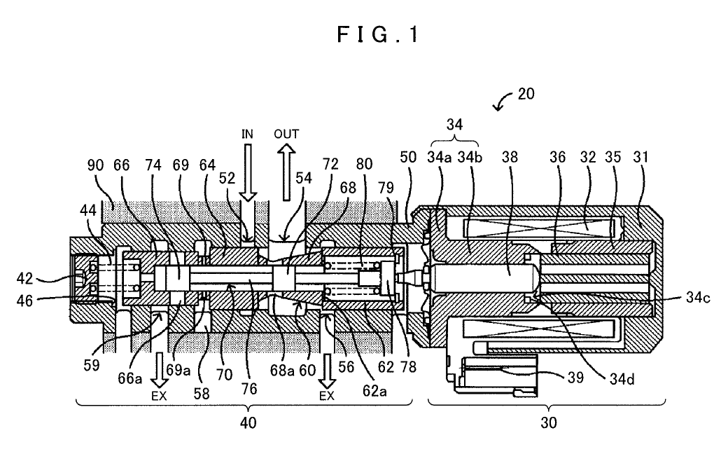

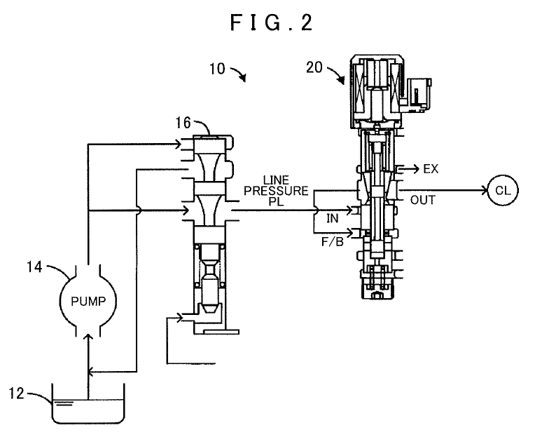

FIG. 1 is a schematic constitutional diagram showing the constitution of a solenoid valve 20 according to an embodiment of the present invention, and FIG. 2 is a schematic constitutional diagram showing the constitution of a hydraulic circuit 10 into which the solenoid valve 20 according to this embodiment is incorporated. As shown in the drawings, the solenoid valve 20 according to this embodiment is a direct control linear solenoid valve to which working oil stored in an oil tank 12 is pumped by an oil pump 14 and which is capable of controlling a clutch CL directly by generating an optimum clutch pressure from an oil pressure (line oil pressure) regulated by a regulator valve 16. The solenoid valve 20 includes a solenoid portion 30, and a pressure regulating valve portion 40 that is driven by the solenoid portion 30 to input the line oil pressure, regulate the input line oil pressure, and output the regulated pressure. The solenoid valve 20 according to this embodiment may be used for hydraulic control of a clutch incorporated into an automatic transmission, for example.

The solenoid portion 30 includes a case 31 formed from a bottomed cylindrical member, a coil (solenoid coil) 32 disposed on an inner peripheral side of the case 31 and formed by winding an insulated conductor wire around an insulating bobbin, a first core 34 constituted by a flange portion 34a having a flange outer peripheral portion that is fixed to an opening end portion of the case 31 and a cylindrical portion 34b that extends in an axial direction around an inner peripheral surface of the coil 32 from the flange portion 34a, a cylindrical second core 35 that contacts an inner peripheral surface of a recessed portion formed in a bottom portion of the case 31 and extends in the axial direction along the inner peripheral surface of the coil 32 to a position distant from the cylindrical portion 34b of the first core 34 by a predetermined interval, a plunger 36 that is inserted into the second core 35 to be slidable in the axial direction along an inner peripheral surface of the first core 34 and an inner peripheral surface of the second core 35, and a shaft 38 that is inserted into the cylindrical portion 34b of the first core 34, contacts a tip end of the plunger 36, and is slidable in the axial direction along an inner peripheral surface of the cylindrical portion 34b. Further, a terminal of the solenoid portion 30 that extends from the coil 32 is connected to a connector portion 39 formed on an outer peripheral portion of the case 31, and the coil 32 is electrified via this terminal.

A tip end portion of the cylindrical portion 34b of the first core 34 is formed with a taper on an outer surface such that an outer diameter thereof decreases toward the tip end, and a plunger receiver 34c is formed in an inner surface so as to be receive a tip end portion of the plunger 36, which has a larger outer diameter than an outer diameter of the shaft 38. The plunger receiver 34c is provided with an annular ring 34d formed from a non-magnetic material such that the plunger 36 does not contact the first core 34 directly.

The case 31, the first core 34, the second core 35, and the plunger 36 are all formed from a ferromagnetic material such as iron having a high degree of purity, and a space between an end surface of the cylindrical portion 34b of the first core 34 and an end surface of the second core 35 is formed to function as a non-magnetic body. Note that as long as this space functions as a non-magnetic body, a non-magnetic metal such as stainless steel or brass may be provided therein.

When the coil 32 is electrified in the solenoid portion 30, a magnetic circuit is formed such that magnetic flux flows around the coil 32 in sequence from the case 31 to the second core 35, the plunger 36, the first core 34, and back to the case 31. As a result, an attractive force acts between the first core 34 and the plunger 36 such that the plunger 36 is attracted. As described above, the shaft 38 that is slidable in the axial direction along the inner peripheral surface of the first core 34 contacts the tip end of the plunger 36, and therefore, as the plunger 36 is attracted, the shaft 38 is pushed forward (in the left direction of the drawing).

The pressure regulating valve portion 40 is incorporated into a valve body 90, and includes a substantially cylindrical sleeve 50, one end of which is attached to the first core 34 by the case 31 of the solenoid portion 30, a hollow outer spool 60 inserted into an interior space of the sleeve 50, an end plate 42 screwed to the other end of the sleeve 50, a spring 44 that is provided between the end plate 42 and the outer spool 60 to bias the outer spool 60 in the direction toward the solenoid portion 30, an inner spool 70 inserted into the interior of the outer spool 60 to be slidable, one end of which contacts the tip end of the shaft 38 of the solenoid portion 30, and a spring 80 that is provided between the outer spool 60 and the inner spool 70 to bias the outer spool 60 and the inner spool 70 relative to each other. Note that by adjusting a screwing position of the end plate 42, a biasing force of the spring 44 can be fine adjusted.

An input port 52 that is formed in a substantially central position of the sleeve 50 in FIG. 1 to input working oil from the regulator valve 16 (oil pump 14), an output port 54 that is formed in a position on the solenoid portion 30 side of the input port 52 to discharge working oil to the clutch CL side, a drain port 56 that is formed in a position on the solenoid portion 30 side of the output port 54 to drain the working oil, and a discharge port 59 for discharging working oil in a feedback chamber 58, to be described below, are formed in the sleeve 50 as opening portions in the interior space thereof. The sleeve 50 is also formed with a step portion 46 such that an inner diameter of a portion of the sleeve 50 to which the end plate 42 is attached is smaller than an inner diameter of a portion of the sleeve 50 in which the outer spool 60 slides, and the step portion 46 functions as a stopper for stopping movement of the outer spool 60.

The outer spool 60 is formed from a hollow shaft-shaped member inserted into the interior of the sleeve 50, and as shown in FIG. 1, includes three columnar lands 62, 64, 66 that slide in the axial direction along an inner wall of the sleeve 50, a connecting portion 68 that connects between the land 62 on the solenoid portion 30 side and the central land 64, among the three lands 62, 64, 66, has a smaller outer diameter than an outer diameter of the lands 62, 64 and is formed in a tapered form such that the outer diameter thereof decreases from the lands 62, 64 toward a central portion, and is capable of connecting the input port 52, the output port 54, and the drain port 56 to each other, and a connecting portion 69 that connects the central land 64 to the land 66 on the end plate 42 side, and forms the feedback chamber 58 for causing a feedback force to act on the spool 60 together with inner wall of the sleeve 50. Note that the land 66 on the end plate 42 side has a smaller outer diameter than the central land 64, and due to a surface area difference between the land 64 and the land 66, the feedback force acts on the solenoid portion 30 side. Further, the land 62 on the solenoid portion 30 side is formed with a step portion 62a having a larger inner diameter than an inner diameter of the adjacent connecting portion 68, and one end of the spring 80 contacts the step portion 62a.

The inner spool 70 includes two columnar lands 72, 74 that slide in the axial direction along an inner wall of the outer spool 60, a shaft portion 76 that connects the two lands 72, 74, extends from the land 72 toward the solenoid portion 30, and has a smaller outer diameter than those of the lands 72, 74, and a columnar portion 78 that is connected to the shaft portion 76 and contacts the shaft 38 of the solenoid portion 30.

The connecting portion 68 and the connecting portion 69 of the outer spool 60 are respectively formed with through holes 68a, 69a that connect the exterior and interior thereof, and the land 66 on the end plate 42 side is also formed with a through hole 66a that connects the exterior and interior thereof. When the inner spool 70 moves toward the solenoid portion 30 relative to the outer spool 60, the through hole 68a is opened while the through hole 66a is blocked by the land 74. As a result, the working oil in the feedback chamber 58 is prevented from being discharged via the through hole 66a, while the working oil on the output port 54 side is introduced into the feedback chamber 58 via the through hole 68a, a space surrounded by the outer spool 60 and the lands 72, 74 of the inner spool 70, and the through hole 69a in that order. When the outer spool 60 moves toward the end plate 42 and the inner spool 70 moves toward the end plate 42 relative to the outer spool 60 so as to contact the outer spool 60, the through hole 68a is blocked by the land 72 while the through hole 66a communicates with the discharge port 59. As a result, the working oil on the output port 54 side is prevented from being introduced into the feedback chamber 58, while the working oil in the feedback chamber 58 is discharged from the discharge port 59 via the through hole 69a, the space surrounded by the outer spool 60 and the lands 72, 74 of the inner spool 70, and the through hole 66a in that order.

The other end of the spring 80 contacts a surface of the columnar portion 78 of the inner spool 70 on the end plate 42 side, and the spring 80 biases the columnar portion 78 toward the solenoid portion 30 using a reaction force from the step portion 62a side of the land 62 of the outer spool 60. Further, a C-shaped snap ring (hereinafter referred to as a C ring) 79 is attached to an inner wall of the land 62 of the outer spool 60 on the solenoid portion 30 side to function as a stopper that contacts the columnar portion 78 and prohibits further movement of the columnar portion 78 when the solenoid portion 30 is OFF and the columnar portion 78 is biased toward the solenoid portion 30 by the spring 80.

As will be described in detail below, the spring 80 is interposed in a contracted condition between the outer spool 60 and the inner spool 70 in an initial state where the solenoid portion 30 is OFF, and is designed to be capable of receiving precisely a load applied to the outer spool 60 by the feedback force that acts on the outer spool 60 when an output pressure reaches a predetermined pressure, and a load applied to the outer spool 60 by the biasing force of the spring 44.

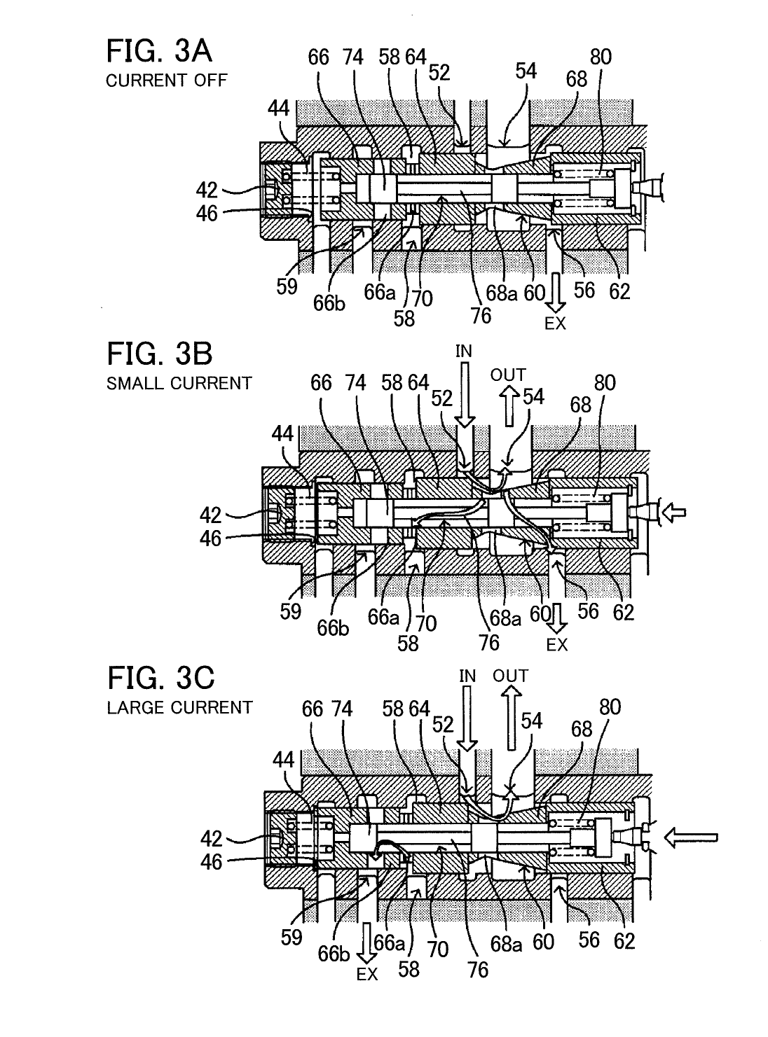

Next, an operation of the solenoid valve 20 according to this embodiment thus constituted will be described. FIGS. 3A to 3C are illustrative diagrams illustrating an operation of the solenoid valve 20 according to this embodiment. First, a case in which electrification of the coil 32 is switched OFF will be considered. In this case, the outer spool 60 is moved toward the solenoid portion 30 by the biasing force of the spring 44, and therefore the input port 52 is closed by the land 64 such that the input port 52 and output port 54 are disconnected, and the output port 54 is connected to the drain port 56 via the connecting portion 68 (see FIG. 3A). Hence, no oil pressure acts on the clutch CL. Further, the inner spool 70 is pushed toward the solenoid portion 30 relative to the outer spool 60 by the biasing force of the spring 80, and therefore the output port 54 communicates with the feedback chamber 58 via the through hole 68a, the interior space of the outer spool 60, and the through hole 69a. Next, when electrification of the coil 32 is switched ON, the plunger 36 is attracted to the first core 34 by an attractive force corresponding to the magnitude of the current applied to the coil 32, and as a result, the shaft 38 is pushed out such that the inner spool 70 contacting the tip end of the shaft 38 is pushed. As described above, the spring 80 is designed to be capable of receiving precisely the loads applied to the outer spool 60 by the feedback force and the biasing force of the spring 44, and therefore, even when the inner spool 70 is pushed, the spring 80 does not contract, and the outer spool 60 moves toward the end plate 42 while substantially maintaining relative positional relationship between the outer spool 60 and the inner spool 70. As a result, the input port 52, output port 54, and drain port 56 enter a state of mutual communication, whereby a part of the working oil input through the input port 52 is output to the output port 54 and the remainder is output to the drain port 56 (see FIG. 3B). Furthermore, since the output port 54 communicates with the feedback chamber 58, a feedback force corresponding to the output pressure of the output port 54 acts on the outer spool 60 in the direction toward the solenoid portion 30. Hence, the outer spool 60 stops in a position where the thrust (attractive force) of the plunger 36, the spring force of the spring 44, and the feedback force of the feedback chamber 58 are precisely counterbalanced. At this time, the outer spool 60 moves further toward the end plate 42 as the current applied to the coil 32 increases, in other words, as the thrust of the plunger 36 increases, and as a result, an opening surface area of the input port 52 is increased and an opening surface area of the drain port 56 is reduced. When the current applied to the coil 32 increases further and the feedback force increases, the spring 80 contracts such that the inner spool 70 moves toward the end plate 42 relative to the outer spool 60. As a result, the through hole 68a is blocked by the land 72 such that the working oil on the output port 54 side is prevented from entering the feedback chamber 58 and the working oil in the feedback chamber 58 is discharged through the discharge port 59. Hence, the feedback force stops acting on the outer spool 60, and therefore the outer spool 60 moves toward the end plate 42 even though the thrust applied from the solenoid portion 30 is comparatively small. As a result, the input port 52 is connected to the output port 54 by the connecting portion 68, the drain port 56 is blocked by the land 62, and the output port 54 and the drain port 56 are disconnected (see FIG. 3C). Accordingly, a maximum oil pressure acts on the clutch CL. Note that movement of the inner spool 70 is stopped when a surface of the land 74 on the end plate 42 side contacts the outer spool 60. Hence, in the solenoid valve 20 according to this embodiment, because the input port 52 is disconnected from the output port 54 and the output port 54 is connected to the drain port 56 when electrification of the coil 32 is OFF, it can be seen that the solenoid valve 20 functions as a normally closed solenoid valve.

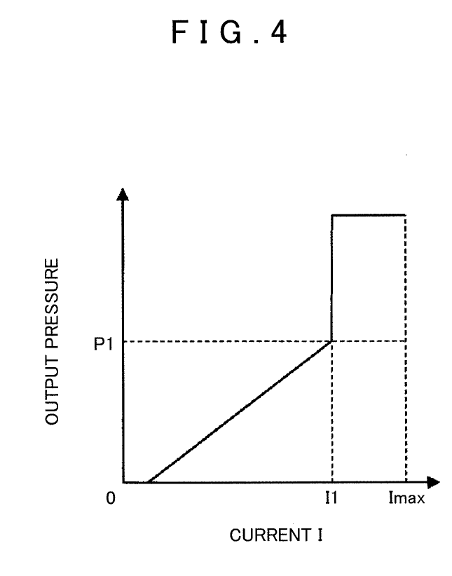

FIG. 4 is an illustrative diagram showing a relationship between a current I applied to the coil 32 and the output pressure. As shown in the drawing, when the current I applied to the coil 32 is smaller than a predetermined current I1, the output pressure varies linearly up to a predetermined pressure P1 relative to variation in the current I, and when the current I applied to the coil 32 exceeds the predetermined current I1, the output pressure varies in a stepwise manner from the predetermined pressure P1 relative to variation in the current I. In this embodiment, the spring 80 is designed to be capable of receiving precisely the total load of the load applied to the outer spool 60 by the feedback force generated when the output pressure is at the predetermined pressure P1 and the load applied to the outer spool 60 by the biasing force of the spring 44.

Hence, when the current I applied to the coil 32 is increased to the predetermined current I1, the inner spool 70 begins to move relative to the outer spool 60, thereby closing the feedback chamber 58. Once the feedback chamber 58 is closed and the feedback pressure is decreased, the outer spool 60 is moved by a comparatively small current increase. In this way, the output pressure can be set at the maximum oil pressure. Thus, the thrust required in the solenoid portion 30 can be reduced, enabling reduction in the size of the solenoid portion 30.

With the solenoid valve 20 according to the embodiment described above, the spool is constituted by the outer spool 60 and the inner spool 70 contacting the shaft 38 of the solenoid portion 30, and the spring 80, which is interposed between the outer spool 60 and the inner spool 70, is designed to be capable of receiving precisely the total load of the load applied to the outer spool 60 by the feedback force generated when the output pressure is at the predetermined pressure P1 and the load applied to the outer spool 60 by the biasing force of the spring 44. Therefore, when the inner spool 70 is pushed by the solenoid portion 30, the input port 52, output port 54, and drain port 56 formed in the sleeve 50 can be opened and closed by moving the outer spool 60 in the axial direction via the spring 80. Further, when the inner spool 70 is moved by applying thrust from the solenoid portion 30, the feedback chamber 58 is closed such that no feedback force acts, and when the thrust from the solenoid portion 30 is reduced, the feedback chamber 58 is opened by moving the inner spool 70 using the biasing force of the spring 80. Hence, in comparison with a constitution in which the feedback chamber is opened by applying thrust from the solenoid portion 30 from a state in which the feedback chamber is closed, the feedback pressure can be restored quickly, enabling reduction in hysteresis of the output pressure. When the output pressure of the output port 54 is high, the feedback chamber 58 is closed by the inner spool 70 such that no feedback pressure acts on the outer spool 60, and therefore the thrust required by the solenoid portion 30 can be reduced, enabling reduction in the size of the solenoid portion 30.

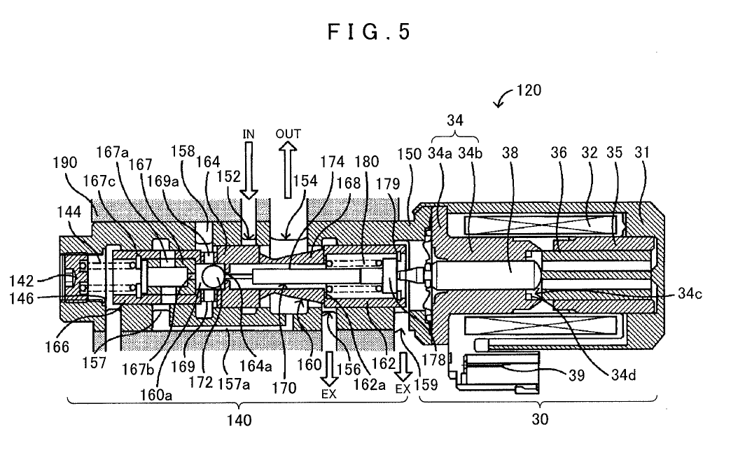

In the solenoid valve 20 according to this embodiment, the inner spool 70 is constituted such that the feedback chamber 58 is opened and closed using the lands 72, 74. However, the present invention is not limited thereto, and as shown by a solenoid valve 120 according to a modified example shown in FIG. 5, opening and closing of a feedback chamber 158 may be switched using a ball 172. In the solenoid valve 120 according to this modified example, because an identical solenoid portion to the solenoid portion 30 of the solenoid valve 20 according to the embodiment is used, description of the solenoid portion 30 will be herein omitted. In the solenoid valve 120 according to the modified example, a pressure regulating valve portion 140 is incorporated into a valve body 190, and similarly to the solenoid valve 20 according to the embodiment, includes a sleeve 150, an outer spool 160, an inner spool 170, an end plate 142, a spring 144 that biases the outer spool 160 toward the solenoid portion 30 using the end plate 142 as a spring receiver, and a spring 180 interposed between the outer spool 160 and inner spool 170 to bias the outer spool 160 and inner spool 170 relative to each other. The sleeve 150 is formed with an input port 152, an output port 154, a drain port 156, a feedback hole 157 for introducing output pressure on the output port 154 side into the feedback chamber 158 via an oil passage 157a surrounded by the sleeve 150 and the valve body 190, and a discharge port 159 for discharging the working oil in the feedback chamber 158. The outer spool 160 is formed as a hollow shaft-shaped member inserted into the interior of the sleeve 150, and includes three columnar lands 162, 164, 166 that slide along an inner wall of the sleeve 150 in the axial direction, a connecting portion 168 that connects the land 162 on the solenoid portion 30 side to the central land 164, among the three lands 162, 164, 166, and is capable of connecting the input port 152, the output port 154, and the drain port 156 to each other, and a connecting portion 169 that connects the central land 164 to the land 166 on the end plate 142 side and forms the feedback chamber 158 for causing feedback force to act on the spool 160, together with the inner wall of the sleeve 150. Note that the land 166 on the end plate 142 side has a smaller outer diameter than that of the central land 164, and due to a surface area difference between the land 164 and the land 166, the feedback force acts on the solenoid portion 30 side. Furthermore, in the outer spool 160, the connecting portion 169 is formed with a through hole 169a that connects the exterior and interior thereof, and in a portion in which the through hole 169a is formed, an interior space 160a is formed by a hollow partition member 167 fixed to the interior of the land 166 and a portion in which an inner diameter of the outer spool 160 is partially reduced. The partition member 167 is formed with a through hole 167a that penetrates the partition member 167 and the land 166, and connects the exterior and interior thereof, and a connecting hole 167b that connects the feedback hole 157 to the interior space 160a via the through hole 167a, and a connecting hole 164a is formed from the portion in which the inner diameter of the outer spool 160 is partially reduced. The inner spool 170 includes the ball 172, which is disposed in the interior space 160a, a shaft portion 174 that has a tip end shape that is considerably smaller than an inner diameter of the connecting hole 164a, and is inserted into the connecting hole 164a so as to contact the ball 172, and a columnar portion 178 that is connected to the shaft portion 174, contacts the shaft 38 of the solenoid portion 30, and has an inner diameter that is considerably smaller than the land 162 of the outer spool 160. Hence, when the inner spool 170 moves toward the solenoid portion 30 relative to the outer spool 160, output pressure causes the ball 172 to close the connecting hole 164a and open the connecting hole 167b, whereby the working oil in the feedback chamber 158 is prevented from being discharged and the working oil on the output port 154 side is introduced into the feedback chamber 158 via the feedback hole 157, the through hole 167a, the connecting hole 167b, and the through hole 169a, in that order. When the outer spool 160 moves toward the end plate 142 and the inner spool 170 moves toward the end plate 142 relative to the outer spool 160, the ball 172 is pushed to the end plate 142 side by the shaft portion 174, thereby closing the connecting hole 167b and opening the connecting hole 164a, and as a result, the working oil on the output port 154 side is prevented from being introduced into the feedback chamber 158 and the working oil in the feedback chamber 158 is discharged through the discharge port 159 via the through hole 169a, the connecting hole 164a, and a gap between the outer spool 160 and the shaft portion 174, in that order. A C ring 179 is attached to an inner wall of the land 162 of the outer spool 160 on the solenoid portion 30 side to function as a stopper that contacts the columnar portion 178 so as to prohibit further movement of the columnar portion 178 when the solenoid portion 30 is OFF and the columnar portion 178 is biased toward the solenoid portion 30 by the spring 180. Similarly to the solenoid valve 20 according to the embodiment, the spring 180 is interposed between the outer spool 160 and the inner spool 170 in a contracted condition in the initial state, i.e. when electrification of the solenoid portion 30 is OFF, and is designed to be capable of receiving precisely the load applied to the outer spool 160 by the feedback force that acts on the outer spool 160 when the output pressure reaches the predetermined pressure, and the load applied to the outer spool 160 by the biasing force of the spring 144.

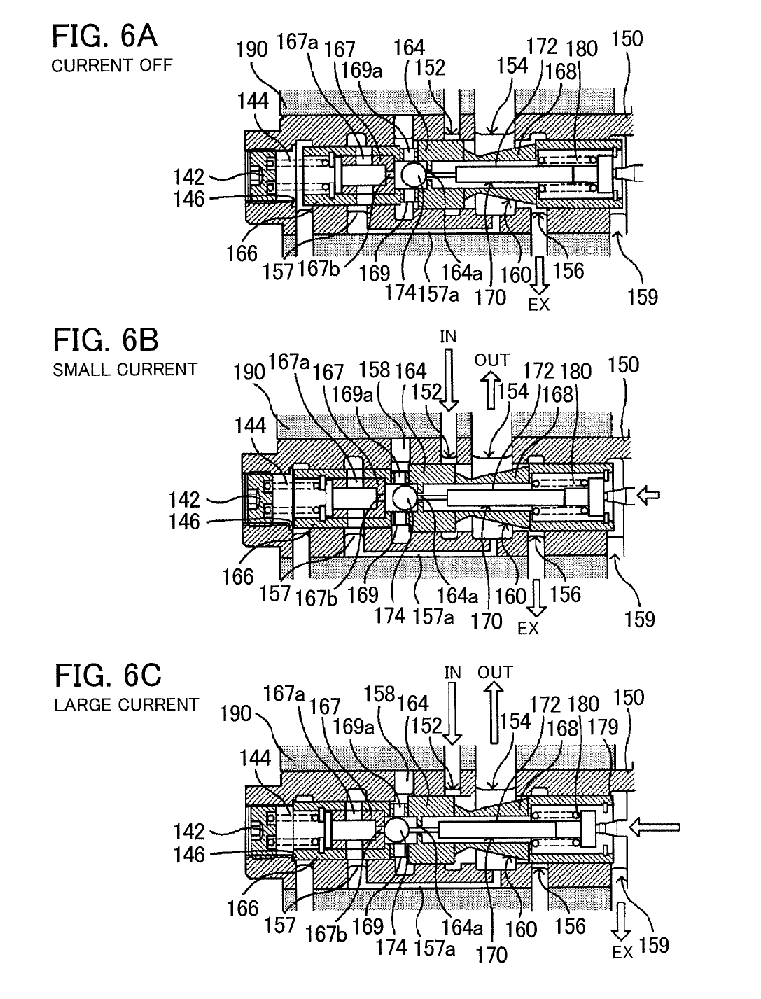

Next, an operation of the solenoid valve 120 according to the modified example thus constituted will be described. FIGS. 6A to 6C are illustrative diagrams illustrating an operation of the solenoid valve 120 according to this modified example. First, a case in which electrification of the coil 32 is switched OFF will be considered. In this case, the outer spool 160 is moved toward the solenoid portion 30 by the biasing force of the spring 144, and therefore the input port 152 is closed by the land 164 such that the input port 152 and output port 154 are disconnected, and the output port 154 is connected to the drain port 156 via the connecting portion 168 (see FIG. 6A). Hence, no oil pressure acts on the clutch CL. Further, the inner spool 170 is pushed toward the solenoid portion 30 relative to the outer spool 160 by the biasing force of the spring 180, and therefore the output port 154 communicates with the feedback chamber 158 via the oil passage 157a, the feedback hole 157, the through hole 167a, the connecting hole 167b, and the through hole 169a. Next, when electrification of the coil 32 is switched ON, the plunger 36 is attracted to the first core 34 by an attractive force corresponding to the magnitude of the current applied to the coil 32, and as a result, the shaft 38 is pushed out such that the inner spool 170 contacting the tip end of the shaft 138 is pushed. The spring 180 is designed to be capable of receiving precisely the loads applied to the outer spool 160 by the feedback force and the biasing force of the spring 144, and therefore, even when the inner spool 170 is pushed, the spring 180 does not contract, and the outer spool 160 moves toward the end plate 142 while substantially maintaining relative positional relationship between the outer spool 160 and the inner spool 170. As a result, the input port 152, output port 154, and drain port 156 are placed in communication with each other, whereby a part of the working oil input through the input port 152 is output to the output port 154 and the remainder is output to the drain port 156 (see FIG. 6B). Furthermore, since the output port 154 communicates with the feedback chamber 158, a feedback force corresponding to the output pressure of the output port 154 acts on the outer spool 160 in the direction toward the solenoid portion 30. Hence, the outer spool 160 stops in a position where the thrust (attractive force) of the plunger 36, the spring force of the spring 144, and the feedback force of the feedback chamber 158 are precisely counterbalanced. At this time, the outer spool 160 moves further toward the end plate 142 as the current applied to the coil 32 increases, in other words, as the thrust of the plunger 36 increases, and as a result, an opening surface area of the input port 152 is increased and an opening surface area of the drain port 156 is reduced. When the current applied to the coil 32 increases further and the feedback force increases, the spring 180 contracts such that the inner spool 170 moves toward the end plate 142 relative to the outer spool 160. As a result, the shaft portion 174 pushes the ball 172 such that the connecting hole 167b is blocked by the ball 172 and the connecting hole 164a is opened, whereby the working oil on the output port 154 side is prevented from entering the feedback chamber 158 and the working oil in the feedback chamber 158 is discharged through the discharge port 159 via the connecting hole 164a and the gap formed between the outer spool 160 and the shaft portion 174. Hence, the feedback force stops acting on the outer spool 160, and therefore the outer spool 160 moves toward the end plate 142 even though the thrust applied from the solenoid portion 30 is comparatively small. As a result, the input port 152 is connected to the output port 154 by the connecting portion 168, the drain port 156 is blocked by the land 162, and the output port 154 and the drain port 156 are disconnected (see FIG. 6C). Accordingly, the maximum oil pressure acts on the clutch CL. Note that movement of the inner spool 170 is stopped when the ball 172 contacts a portion in which the connecting hole 167b is formed.

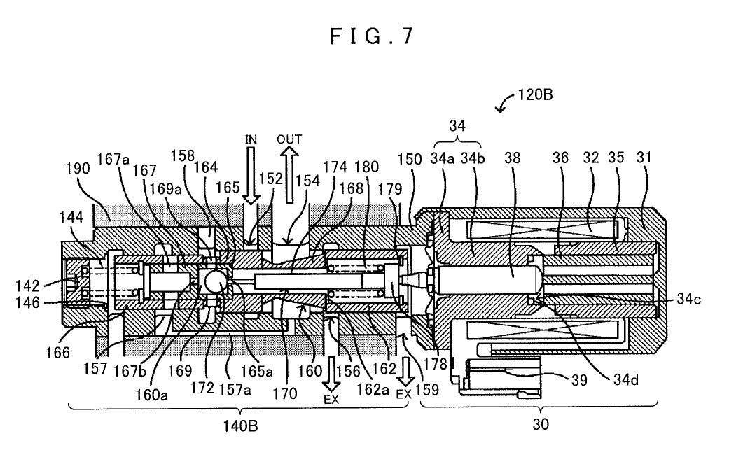

In the solenoid valve 120 according to this modified example, the connecting hole 164a for discharging working oil from the interior of the feedback chamber 158 through the discharge port 159 is formed by partially reducing the inner diameter of the outer spool 160. As shown by a solenoid valve 120B according to a modified example shown in FIG. 7, however, a partition member 165 formed with a connecting hole 165a may be provided in the interior of the outer spool 160 as a separate body.

The solenoid valve 20 according to the embodiment and the solenoid valves 120, 120B according to the modified examples are formed as normally closed solenoid valves, but may be formed as normally open solenoid valves.

In the solenoid valve 20 according to the embodiment and the solenoid valves 120, 120B according to the modified examples, the pressure regulating valve portion 40, 140 including the sleeve 50, 150 is incorporated into the valve body 90, 190, but the solenoid valve may be constructed by forming a sleeve portion integrally with a valve body and inserting a spool and so on into the sleeve portion.

The solenoid valve 20 according to the embodiment and the solenoid valves 120, 120B according to the modified examples are used in the hydraulic control of the clutch CL incorporated into the automatic transmission, but may be used in fluid pressure control of any operating mechanism operated by fluid pressure.

Here, correspondence relation between the main elements of the embodiment and main elements of the invention described in the Summary of the Invention will be described. In the embodiment, the sleeve 50 corresponds to a “sleeve”, the solenoid portion 30 corresponds to a “solenoid portion”, the outer spool 60 corresponds to a “first spool”, the inner spool 70 corresponds to a “second spool”, and the spring 80 corresponds to a “biasing member”. Further, the spring 44 corresponds to a “second biasing member”. Note that the correspondence relation between the main elements of the embodiment and main elements of the invention described in the Summary of the Invention is an example for illustrating specifically the embodiment of the invention described in the Summary of the Invention, and therefore does not limit the elements of the invention described in the Summary of the Invention. In other words, the invention described in the Summary of the Invention should be interpreted on the basis of the description in that section, and the embodiment is merely a specific example of the invention described in the Summary of the Invention.

The embodiment of the present invention has been described above, but the present invention is not limited in any way to this embodiment, and may be implemented in various embodiments within a scope that does not depart from the spirit of the present invention.

The present invention can be used in the automobile industry.

1. A solenoid valve comprising:
a hollow sleeve formed with ports including an input port, an output port, and a discharge port, a spool that is a shaft-shaped member inserted into an interior of the sleeve and connects and disconnects the respective ports; and
a solenoid portion that moves the spool in an axial direction, wherein
the spool includes:
a first spool which forms a feedback chamber, into which an output pressure is introduced, together with the sleeve, and which is capable of regulating an input pressure from the input port and outputting the regulated input pressure to the output port by moving in the axial direction while receiving a feedback force;
a second spool which is pushed by the solenoid portion and switched so as to introduce the output pressure into the feedback chamber and close the feedback chamber; and
a biasing member which is provided between the first spool and the second spool so as to bias the first spool and the second spool relative to each other, and
the biasing member is formed such that when the second spool is pushed by the solenoid portion, the first spool is pushed from the second spool via the biasing member so as to move in the axial direction.

2. The solenoid valve according to claim 1, wherein
when an initial state in which the solenoid portion is OFF and the output pressure has a value of substantially zero is established, the feedback chamber is open,
when the output pressure is low, the feedback chamber is kept open as the second spool is pushed by the solenoid portion such that the first spool is pushed and moved without causing the biasing member to contract, and
when the output pressure becomes high in accordance with the movement of the first spool, an additional pushing force is applied to cause the solenoid portion to push the second spool, and the second spool moves relative to the first spool while the biasing member contracts such that the feedback chamber is closed by the second spool.

3. The solenoid valve according to claim 1, wherein the biasing member is formed such that in the initial state where the solenoid portion is OFF, a predetermined initial load acts on the first spool and the second spool.

4. The solenoid valve according to claim 3, further comprising a second biasing member that biases the first spool in an opposite direction to a direction of the pushing force from the solenoid portion, wherein
the feedback chamber is formed such that the feedback force acts in an identical direction to a biasing direction of the second biasing member, and
the initial load is set on the basis of a biasing force of the second biasing member and the feedback force.

5. The solenoid valve according to claim 4, wherein
when a current applied to the solenoid portion is smaller than a predetermined value, the output pressure varies linearly relative to variation in the applied current, and when the current applied to the solenoid portion reaches or exceeds the predetermined value, the output pressure varies in a substantially stepwise manner relative to variation in the applied current, and
the initial load is set on the basis of a total load of a load applied to the first spool by a feedback force based on the output pressure when the current applied to the solenoid portion reaches the predetermined value and a load applied to the first spool by the second biasing member.

6. The solenoid valve according to claim 1, wherein
a discharge passage is formed to discharge a working fluid from the interior of the feedback chamber, and
the second spool is formed to block the discharge passage when opening the feedback chamber and open the discharge passage when closing the feedback chamber.

7. The solenoid valve according to claim 1, wherein
the first spool is a hollow member, and
the second spool is inserted into the first spool to be slidable in the axial direction such that a movable range of the second spool is restricted by the first spool.
